(19) United States
(12) Patent Application Publication
(10) Pub. No.: US 2020/0144844 A1
(43) Pub. Date: May 7, 2020

(54) Method and system for delivering controlled content in wireless charging

(71) Applicant: Haifeng Chen, Shenzhen (CN)

(72) Inventor: Haifeng Chen, Shenzhen (CN)

(21) Appl. No.: 16/177,445

(22) Filed: Nov. 1, 2018

(51) Int. Cl. H02J 7/02; G06Q 30/02; G06Q 50/06; H02J 7/00

(52) U.S. Cl. CPC H02J 7/025; H02J 7/0021; G06Q 50/06; G06Q 30/0207

(57) ABSTRACT

Techniques for managing a plurality of wireless charging pads are described. According to one aspect of the present invention, each of these charging pads receives an instruction from a server before operating to charge a mobile device placed thereon or nearby. The instruction is generated to ensure that a user gets a free charging or charged for a fee based on a status of an account associated with the user. In particular, a user may view targeted messages allocated specifically for the user to earn a payment or credits that may be used to pay for charging from a charging pad.

### BACKGROUND

### Technical Field

The present invention is related to the area of wireless charging, and in particular, to the management of charging devices and delivery of controlled content to a mobile device when the mobile device is wirelessly charged with one of the charging devices.

### Related Art

Mobile phones (e.g., iPhones) are considered as personal necessities nowadays. A mobile phone (e.g., iPhone) is a powerful form of communication and represents functionality and style in one small package. Billions of people worldwide are now owners of mobile phones. Interestingly enough, based on some studies, some countries in the European region now have more mobile phones than people, implying the actual number of handset subscriptions in a particular country is larger than the actual number of people living in the country. On the other hand, in some developing countries, with little telecommunications infrastructure, this is the technology that gives their people access to various services that are otherwise not available locally.

Mobile phones are often powered by batteries that are needed to be recharged from time to time. Various technologies have been developed, for example, to expand the charging capacities or extend the life of the batteries. Depending on how a mobile device is used, the batteries in a mobile device have to be charged periodically, otherwise risking the possibility of having a non-operational device when it is needed. Examples include a situation in which a user runs into a store asking for a power socket to recharge his/her mobile device, or a call is suddenly interrupted because of the power failure of the batteries. Wireless charging technologies are introduced to facilitate the easy charging of the phones. Instead of getting a data line or power cable to charge a mobile device, a charging pad is provided to allow a mobile device simply sitting thereon to get charged wirelessly, for example, via radio, induction, or resonance.

For the convenience of its customers, a store may provide a few charging pads to allow its customers to charge their mobile devices while in the store. However, it is a challenge to manage the power to the charging pads, especially when there is a significant number of charging pads provided. The present disclosure teaches respective mechanisms to manage a plurality of charging pads and allow a business establishment to make the best use of their managed charging pads when users charge their mobile devices while in the establishment.

### SUMMARY

This section is for the purpose of summarizing some aspects of the present invention and to briefly introduce some preferred embodiments. Simplifications or omissions in this section as well as in the abstract and the title may be made to avoid obscuring the purpose of this section, the abstract and the title. Such simplifications or omissions are not intended to limit the scope of the present invention.

Generally speaking, the present invention is related to the management of wireless charging pads. According to one aspect of the present invention, each of these charging pads receives an instruction from a server before operating to charge a mobile device placed thereon or nearby. The instruction is generated to ensure that a user gets a free charging or charged for a fee based on a status of an account associated with the user.

According to another aspect of the present invention, credits may be earned in or awarded to an account by viewing targeted messages specifically prepared for the user. By viewing selectively some or all of the targeted messages during charging or at leisure time, depending on the time, locations and content, the user gets credits and may use them for free charging.

According to still another aspect of the present invention, various advertisements (ads) are prepared or allocated based on a profile of the user. The allocated ads are shown in an order when the user views them. The ads may be ordered based on a pay rate offered by their advertisers. A higher pay rate means more points, thus creating a bidding process among the advertisers to place their ads before the user. Extra points or credits may be earned when the user interacts with a displayed message Depending on the viewing activities or any transactions related to one of the ads, the profile of the user is periodically updated or as needed while the allocated ads are also dynamically updated in accordance with the viewing activities or transactions.

According to still another aspect of the present invention, the advertisers are charged to subsidize the operation of the charging pads by a business establishment. Providing free charging may be an incentive to attract more visitors or retain them longer in the business establishment.

According to still another aspect of the present invention, an installed application is activated when a mobile device is placed upon or near a charging pad. The mobile device may be required to install or activated to register with a designated entity (e.g., a publisher or a business establishment) in order to start charging the mobile device. The profile of a user associating with the mobile device may be initially established and gradually updated as the user keeps using the charging facilities. The profile may record where and when the user has visited and his/her viewing activities.

According to still another aspect of the present invention, the installed application in the mobile device can get an exact location via a charging pad. Content (e.g., advertisements) may be prepared in conjunction of the exact location of the user and subsequently delivered to the mobile device, where the content is displayed while the mobile device is being wirelessly charged.

According to yet another aspect of the present invention, the exact location of the user and a profile thereof may be provided to a plurality of businesses to compete for a time slot to show an advertisement deemed interesting to the user. Additional competition for a supplemental advertising opportunity is held with another set of businesses when an advertisement is consummated by the user, where a new advertisement provides goods or services supplemental to what was promoted in the previous advertisement and consummated by the user.

The present invention may be implemented in various forms including a method, an apparatus or part of a system. According to one embodiment, the present invention is a system for wireless charging management, the system comprises a server managing remotely a plurality of charging pads, each of the charging pads being disposed in an establishment to allow mobile devices to get wireless charging therefrom. Each of the charging pads includes a charging interface detecting a presence of a mobile device when the mobile device is placed near or on top of a charging pad, a controller coupled to the charging interface and programmed to send out a signal activating a designated application installed in the mobile device to be executed therein, and a network interface receiving a set of parameters from the server responding to a data set received from the mobile device over a data network, wherein the controller controls charging service so that the each of the charging pads starts or refuses charging the mobile device. The data set includes a plurality of parameters that the controller relies upon to reconfigure the charging interface to match with the mobile device for optimum wireless charging.

According to another embodiment, the present invention is a method for wireless charging management, the method comprises receiving in a server a data set from a mobile device over a data network, the data set including an exact location of a charging pad. The charging pad includes a charging interface detecting a presence of the mobile device when the mobile device is placed near or on top of the charging pads, a controller coupled to the charging interface and programmed to send out a signal activating a designated application installed in the mobile device to be executed therein, and a network interface. The method further comprises sending out a set of parameters from the server to the charging pad in responding to the data set, wherein the parameters cause the controller to start or refuse charging the mobile device from the charging pad.

One of the advantages, benefits and objectives of the present inventions is to manage a plurality of charging pads or stations effectively with the delivery of targeted messages to the devices to be or being charged. There is no need to plug and unplug each time, just place a device on top or near a charging pad.

There are many other objects, together with the foregoing attained in the exercise of the invention in the following description and resulting in the embodiment illustrated in the accompanying drawings.

### BRIEF DESCRIPTION OF THE DRAWINGS

These and other features, aspects, and advantages of the present invention will become better understood with regard to the following description, appended claims, and accompanying drawings where:

FIG. 1A shows a view of wireless charging, in which a mobile device is placed above or near a wireless charging pad;

FIG. 1B shows an exemplary configuration of providing wireless charging on a table according to one embodiment of the present invention;

FIG. 1C shows a functional block diagram of an exemplary charging pad that may be used in FIG. 1B;

FIG. 1D shows a system configuration of how a charging pad is activated by a mobile device and managed by a designated server;

FIG. 1E shows some exemplary screen displays on a mobile device when the mobile device is placed on or near a charging pad;

FIG. 2A shows an example of an interface that may be used in the charging interface of FIG. 1C;

FIG. 2B shows one example of an adaptive interface that includes a plurality of self-reconfigurable inductors;

FIG. 3 shows a flowchart or process of providing charging services to a mobile device;

FIG. 4A, there is shown a functional block diagram of a server in which a server module resides in a memory space and is executed by one or more processors; and

FIG. 4B shows an exemplary look-up table that lists registered devices under one or more users according to one embodiment of the present invention.

### DETAILED DESCRIPTION OF THE PREFERRED EMBODIMENTS

The detailed description of the invention is presented largely in terms of procedures, steps, logic blocks, processing, or other symbolic representations that directly or indirectly resemble the operations of a device described in one embodiment of the present disclosure. These process descriptions and representations are typically used by those skilled in the art to most effectively convey the substance of their work to others skilled in the art.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Further, the order of blocks in process, flowcharts or diagrams representing one or more embodiments of the invention do not inherently indicate any particular order nor imply any limitations in the invention.

The present invention pertains to an apparatus, a method, and an application. As used herein, any pronoun references to gender (e.g., he, him, she, her, etc.) are meant to be gender-neutral. Unless otherwise explicitly stated, the use of the pronoun “he”, “his” or “him” hereinafter is only for administrative clarity and convenience. Additionally, any use of the singular or to the plural shall also be construed to refer to the plural or to the singular, respectively, as warranted by the context.

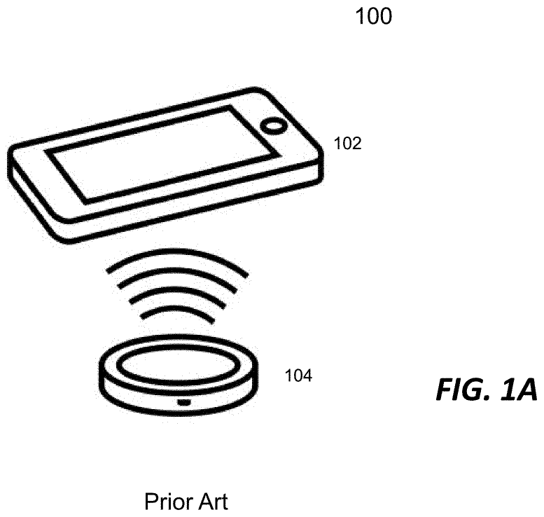

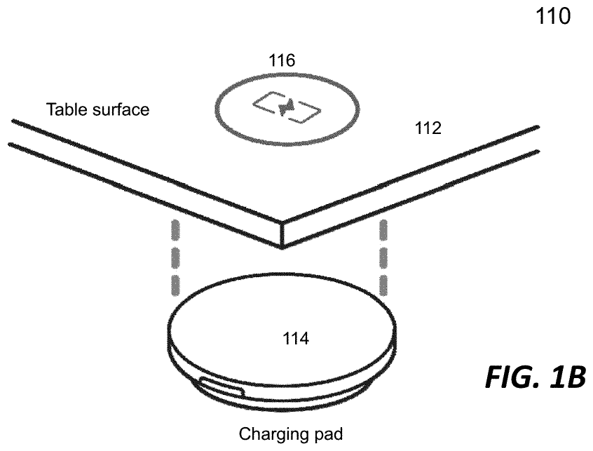

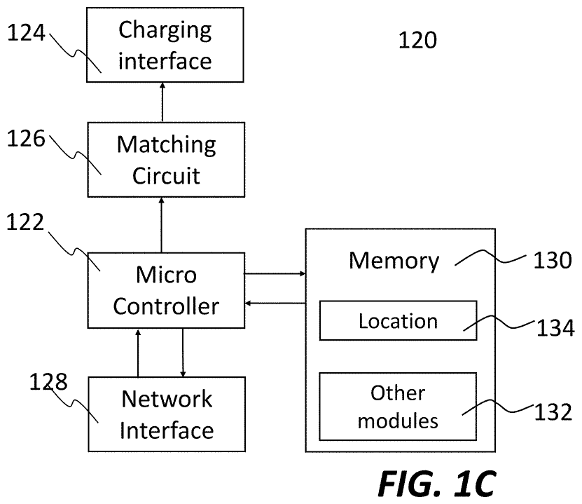

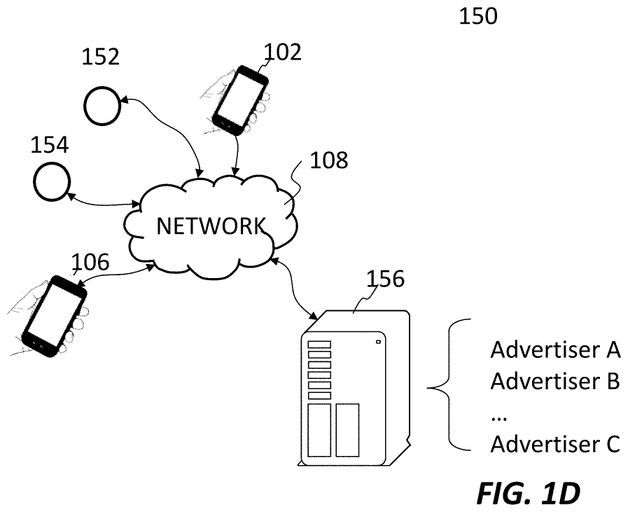

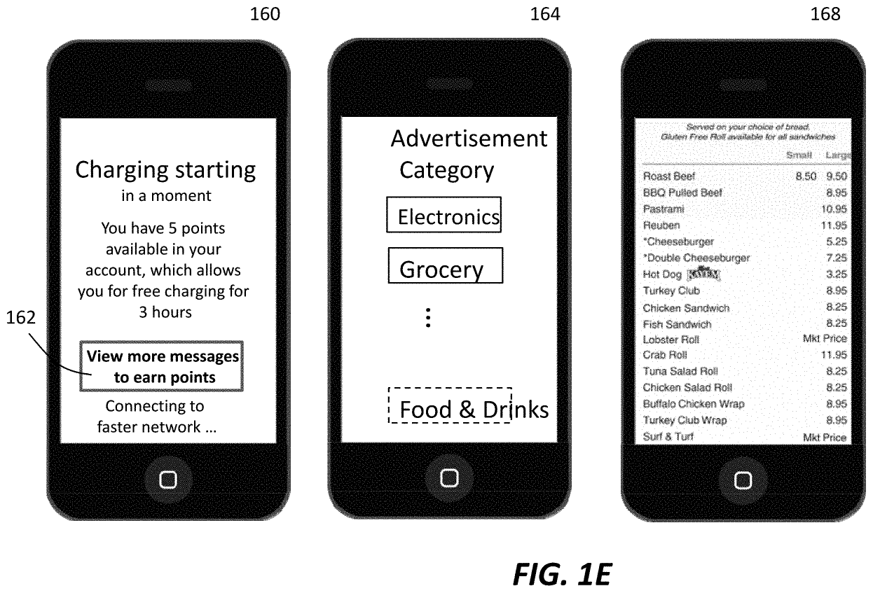

Embodiments of the present invention are discussed herein with reference to FIGS. 1-4. However, those skilled in the art will readily appreciate that the detailed description given herein with respect to these figures is for explanatory purposes as the invention extends beyond these limited embodiments.

Referring now to FIG. 1A, it shows a view 100 of wireless charging, in which a mobile device 102 is placed above or near a wireless charging pad 104. There are no wires or cables between the mobile device 102 and the charging pad 104, hence wirelessly charging. FIG. 1B shows an exemplary configuration 110 of providing wireless charging on a table 112 according to one embodiment of the present invention. A wireless charging pad 114 is concealed under a layer of thin material or a sheet 116 or simply embedded in the table surface, where the sheet 116 may be printed with a sign to indicate where a mobile device may be placed thereon. As a result, a user may simply place his mobile device on top of the sheet 116 or the surface of the table when using the table 112. Without further detailing FIG. 1B, it can be appreciated by those skilled in the art that the wireless charging pad 114 or a plurality of such charging pads are connected to a power source.

FIG. 1C shows a functional block diagram 120 of an exemplary charging pad that may be used in FIG. 1B. It should be noted that there are no explicit physical limitations in the charging pads used in the present invention, although the phase “charging pad” is used throughout herein. Those skilled in the art understand that a charging pad may be designed in any shape. The common design of a pad is intended to make it easy for a mobile device to rest there upon. In any case, the exemplary charging pad includes a microcontroller 122 to synchronize the operations of key components in the charging pad. A charging interface 124 is provided to engage with a mobile device when it is placed near the charging pad. Depending on an implementation, the charging interface may be or include an inductor, an antenna or a coupling circuit. When the mobile device is placed nearby, the coupling circuit detects the presence of the mobile device and notifies the microcontroller 122 that the mobile device is demanding charging. In a prior art charging pad, the microcontroller 122 would simply activate a charging circuit to start charging the mobile device. Different from the prior art charging pad, the microcontroller 122 is designed to operate the charging service in reference to an external command, signal or instruction. In one embodiment, the charging pad is caused to send out a triggering signal (e.g., a Qi enabled signal) that is used to activate an application (referred to as a charging application herein) in the mobile device. If such an application is not installed, the user may be required or have to download the application from a designated place on the Internet (e.g., Apple Store) prior to the use of the charging pad contemplated in one embodiment of the present invention.

It is assumed that the charging application is already installed in the mobile device and now being executed. With the existing Internet or data communication mechanisms already in a mobile device, the charging application causes the mobile device to communicate with a predefined server in response to the triggering signal from the charging pad. The server is designed to control the operation of the charging pad via the network interface 128. In one embodiment, an instruction (e.g., a set of data) is received in the charging pad via the network interface 128. The microcontroller 122 allows the charging circuit to operate for a period (e.g., one hour) in response to the instruction, namely the mobile device can only be charged for a fixed time period. In other words, the server is designed to maintain an account for the mobile device associated with a user thereof. A status of the account allows the server to decide when, how and where the mobile device may receive charging free or at a cost.

There are many types of mobile devices. It is possible to charge various mobile devices without considering the efficiency. However, low-efficient charging would induce heat besides a longer time to a full charge. For example, the inductors or the inductance thereof in different devices may be designed differently, resulting in mismatching with that of the charging pad, hence inefficient charging due to the impedance mismatch. Another mismatch is the different wattage requirement to charge a set of batteries in different mobile devices. For example, a charging pad matched for iPhone from Apple may not work efficiently for Pixel from Google or Mate 20 pro from Huawei.

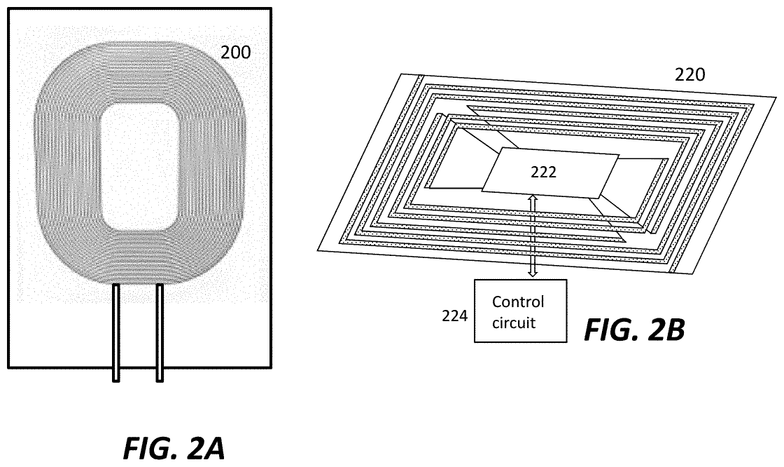

A matching circuit 126 is thus provided to ensure the charging pad matching with a mobile device to be charged. With the installed charging application, all necessary parameters of the mobile device (e.g., make. model, voltage or current as well as wireless charging requirements) can be obtained and known to the predefined server. In one embodiment, the matching circuit 126 works based on a data set received from the server via the network interface 128, where the data set indicates the model and make of the mobile device or simply a set of parameters (e.g., voltage and impedance) provided by the server. FIG. 2A shows an example of an interface 200 that may be used in the charging interface 124 of FIG. 1C. As an example, the interface 200 is implemented as an inductor, hence inductive charging. When a mobile device is placed nearby, a corresponding inductor in the mobile device is coupled to the inductor 200 for forming an electromagnetic field therebetween so as to transfer the power energy from one side to another. In other words, the power energy is sent through an inductive coupling to charge batteries in the mobile device or run the mobile device.

In reference to one embodiment of the present invention, FIG. 2B shows one example of an adaptive interface 220 that includes a plurality of inductors, each having different inductance. These inductors are individually formed (e.g., on a substrate) and may be coupled in parallel or in series via a plurality of switches 222 (e.g., diodes) controlled by a processor (e.g., the microcontroller 122 of FIG. 1C) or a dedicated circuit 224. When the presence of a mobile device is detected, the processor 224 is programmed to determine how to combine some or all of the inductors to best match a corresponding inductor in the mobile device by turning on or off some or all of the switches 222. The detailed circuit of controlling the switches is not to be discussed further here to avoid obscuring important aspects of the present invention. Those skilled in the art shall know various available designs of such a circuit to control the switches 222 or inductors 220 so that the overall inductance matches the same from the mobile device placed nearby for recharging. As a result, any mobile device placed upon a charging pad designed per one embodiment of the present invention may be charged with optimum or at least improved efficiency regardless of the make or model of the device.

Not specifically shown is the use of the circuit 224 to control the voltage required to match that of the batteries in the device being charged. Those skilled in the art well understand a circuit design to reconfigure a required voltage appropriate for charging a mobile device.

Referring back to FIG. 1C, a memory device 130 in certain capacity is provided to store necessary modules 132 or firmware to support the operation of the microcontroller 122. In one embodiment, an exact location of the charging pad may be stored in the memory 130. It should be noted that the exact location is different from a location determined by a mobile device. The exact location is precise and may be coded in or stored therein while the location determined by the mobile device is dynamically based on GPS signals and often off from the exact location. The location determined based on signals (e.g., the GPS signal or Wi-Fi signals) is herein referred to as estimated location. It can be appreciated that the precision of the location of the charging pad is important when a location-based message (e.g., an advertisement or a menu) is delivered to the mobile device while it is being charged.

Referring now to FIG. 1D, it shows a system configuration 150 of how a charging pad is activated by a mobile device and managed by a designated server. Two representative charging pads 152 and 154 are shown. They may be located in one place or two separate places. In one example, the charging pads 152 and 154 are representative of a plurality of charging pads in a store (e.g., a restaurant or a coffee shop). In another example, the charging pads 152 and 154 are respective representative of a plurality of charging pads in two stores (e.g., two shops located remotely with respect to each other). In any case, these charging pads are centrally managed in one or more computing devices 156 (e.g., a designated server 156).

According to one embodiment, a mobile device activates the installed charging application when a current is received, attempting to charge the battery therein. In another embodiment, a charging pad 152 sends out a data set (e.g., Qi-based signals) to activate the installed charging application. In any case, the charging application is designed to communicate with the server 156 when a mobile device is in contact with a charging pad 152 or 154. Optionally, the charging pad may be designed to communicate with the server 156. In one embodiment, a data set received in the server 156 may include an identifier, its exact location, a status thereof and other information about the mobile device. The identifier, the exact location, and the status may be obtained via the charging pad. Given the data set either from the charging application or the charging pad, the server 156 knows well about the specifics of the mobile device. The server 156 is programmed or executes a server module to determine if the mobile device is eligible for free charging or required to pay for the charging.

In one embodiment, the server 156 maintains an account of a user associated with the mobile device. The account includes a profile that may be initially obtained from the user when the account is initially registered with the server 156. The user may use a maintained account to get free charging or pay for the charging.

According to another embodiment, the user gets free charging from a charging pad by viewing designated messages on the screen of the mobile device, either during the charging or at a time convenient time to the user. The designated messages may be commercial or targeted messages. In one embodiment, the commercial messages are advertisements distributed by the business operating a plurality of charging pads. For example, a coffee business (e.g., Starbucks) with multiple locations across a region or a country may operate a plurality of charging pads in each of its shops. A mobile device with an installed charging application distributed by the business or downloaded from a designated store may get free charging while in the shop. The free charging is given to the user provided that the user has agreed to view some of the messages displayed on his mobile device.

In one embodiment, the charging application displays a menu on the mobile device when the mobile device is placed upon a charging pad integrated with a table in a restaurant or in leisure time. The user can order desired dishes right on his mobile device. Once the order is placed, free charging to the mobile device may start. Although the order may be sent to the server, it can be routed back by the server to a computing device in the restaurant. In one embodiment, the server is designed to cause the charging application to display the menu based on the exact location of the charging pad or load a store-specific menu of the location to the charging application for display. In some other examples, a special dish may be promoted on the screen of the mobile device, an order of the dish qualifies the user for something special (e.g., extra points for free charging or credits/discounts for something else being promoted).

FIG. 1E shows some exemplary screen displays on a mobile device when the mobile device is placed on or near a charging pad. The display 160 is shown when the mobile device is on the charging pad. The display 160 is provided to the user to indicate that there is an electrical coupling going on between his mobile device and the charging pad. Depending on implementation, there may be some power (current or voltage) or a data signal being coupled from the charging pad to the mobile device, where the power or the data signal can be interpreted by the controller in the mobile device to activate the charging application. Once the charging application is running, the display 160 is shown. Meanwhile the charging application communicates with the server 156 to verify the status of the user. If needed, the user may be required to sign into the charging application.

The display 160 informs the user if he is qualified for free charging or charged for the charging. In particular, the display 160 shows the available credits or points that may be used for free charging. As shown in FIG. 1E, there is a way to earn the points. A clickable message 162 is shown to allow the user to view allocated messages. It is assumed that the user ahs clicked the message 162. The display 164 shows an exemplary list of advertisements (or ads) categories, each holds one or more ads from corresponding advertisers. It may also be used to show a presence of ads, namely the user has not seen the details of each of the ads before an activation happens. It is assumed that a user decides to check out deals in the category of food & drinks before lunch time. He may activate or click on the “Food & Drinks” category that may lead to a show of a list of available ads related to restaurants, special lunch or dinner deals, and drinks at local stores. For example, there are two available ads from nearby supermarkets, all local to the user at the time of viewing the category. The user may choose one or both to view. In the context of the present invention, these ads are allocated especially for the user who will be compensated for viewing one of the ads if he chooses to do so. In addition, the ads or the categories may be dynamically updated when it is detected that one category or types of ads that the user never views or views extensively.

The display 168 shows an exemplary menu when a user sits in a restaurant. The menu encourages the user to make a selection to earn points. The mobile device sends the order electronically while the mobile device is being charged. In one embodiment, a (dish) promotion may be displayed in a bar or overlaid upon the menu to get attention from the user. An order of the promoted item from the mobile device may earn additional points.

According to another embodiment, an ad is shown when the user enters the category. The one that shows immediately or first is generally the one that the advertiser thereof is willing to pay the viewer the most (e.g., more credits or points). When there are multiple ads that may all fit into the interest of the user, the order of the ads may be arranged based on a pay rate the corresponding advertiser is agreed to pay. A higher pay rate may command an ad to be shown earlier to the user. A bidding process may take place among the advertisers per the profile of the user to secure a preferable place or time of their own ads in a queue formulated or allocated for the user.

It should be noted there are several significant differences between the allocated ads for the user in the present invention and the ads shown in a search engine, for example, Google (www.google.com). Google uses a bidding process among a plurality of advertisers for a limited number of advertising places, whenever these is a search inquiry from a user. Based on the payments, ads from winning advertisers are placed accordingly in the advertising places. First, in Google case, the bidding process takes place when an ad opportunity is happening (per a search inquiry from a user). In the present invention, an opportunity is yet to happen, namely the ads are allocated per the interests of the user in advance. All advertisers are bidding for an opportunity that waits or scheduled to happen. Next, in Google case, the bidding process takes place when the advertisers have no idea who the user may be, all the advertisers are blindly bidding for an ad opportunity to show an ad to someone no who knows who may be looking at the ad, often resulting in showing an ad to someone with no interest at all. In the present invention, the advertisers know who will be looking at the ads. Based on the profile (e.g., employment or income level), the advertisers may even know if the user can afford, the likely chance their ads may be clicked through or a transaction may eventually happen. Even more, in Google case, an advertiser may have to pay a high price again and again for showing an ad to the same user when the user happens to perform repeatedly similar searches. In the present invention, when it is detected that the user does not do anything for a few ads in one category, the payout to the user for viewing the remaining ads in the category shall be automatically reduced, which in return could potentially save the advertising costs of these advertisers.

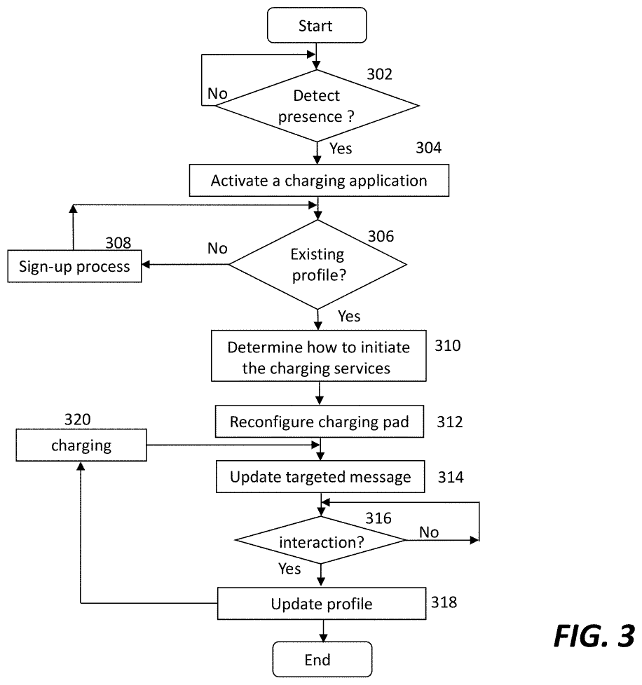

Referring now to FIG. 3, it shows a flowchart or process 300 of providing charging services to a mobile device. The process 300 may be implemented in software or in combination of software and hardware, and may be better understood in conjunction with the previous figures. The process 300 starts when a mobile device is placed upon or near a charging pad.

At 302, the process 300 keeps detecting or periodically if a mobile device is placed near or upon a charging pad. The process 300 moves to 304 to cause the mobile device to activate a designated application (a.k.a., the charging application) in the mobile device. In one embodiment, when the presence is detected, the charging pad sends out a signal to the mobile device via coupling between the mobile device and the charging pad, where the signal is designed to activate the charging application. The charging application communicates with a predefined server (e.g., the server 156 of FIG. 1D). Information or relevant parameters about the mobile device are transported to the server with encryption or in plain text. Upon receiving the data, the server determines if there is an associated account for the user at 306. If no account is located in the server, the process 300 goes to 308, where the user is required to sign up an account so that he may use any of the charging pads under the management.

It is now assumed that there is an account for the mobile device associated with the user. The process 300 now goes to 310, where the server is configured to determine how to provide the charging service to the user, meanwhile determining a set of parameters to reconfigure the charging pad for optimum charging the mobile device placed on the specific charging pad at 312.

As described above, the user may pay for the charging or get free charging by using credits or points that may be awarded or earned via various promotions. One of the promotions, as described herein, is to read or view targeted messages, such as specifically allocated ads. At 310, the server determines how many credits the account has. Depending on the rate that may change from time to time, a total available charging time may be calculated, where the time is transported to the mobile device for display.

At 312, the make and model of the mobile device help determine the parameters to reconfigure the charging interface of the charging pad. In one embodiment, the server maintains a look-up-table of all common mobile devices with corresponding wireless charging interface parameters. The parameters are transported to the charging pad, where the charging pad, as described above, performs self-adjustments to have the matched coupling with the mobile device for optimum charging.

As the mobile device is being charged, the screen thereof is caused to show various targeted messages (e.g., ads). As described above, these ads are allocated in advance and specifically for the user based on the profile thereof. While displaying the ads in a queue allocated previously, the ads are being updated at 314 in reference to the exact location of the charging pad along with the time or the day. In one embodiment, the targeted message may also be a menu from which a user may make orders therefrom. In any case, the process 300 detects at 316 if there is an interaction from the user with a target message (e.g., a click on an ad or an item in the menu). If there is an interaction, the process 300 goes to 318 to update the profile that may be maintained in the mobile device or on the server (eventually synchronized). The interaction may be a clickable act by the user on a specific ad, a purchase from an ad or an order of a list of items (e.g., menu). Such an interaction indicates an interest from the user, facilitating to get more targeted messages in a next round.

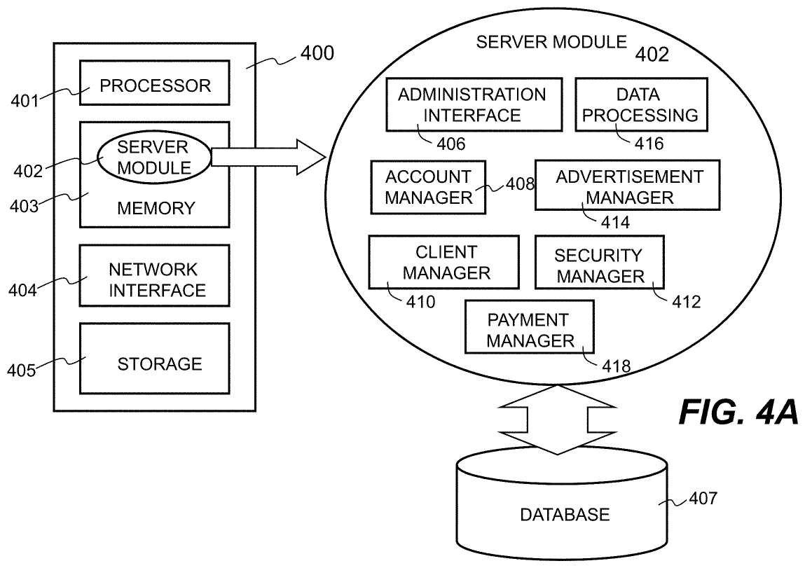

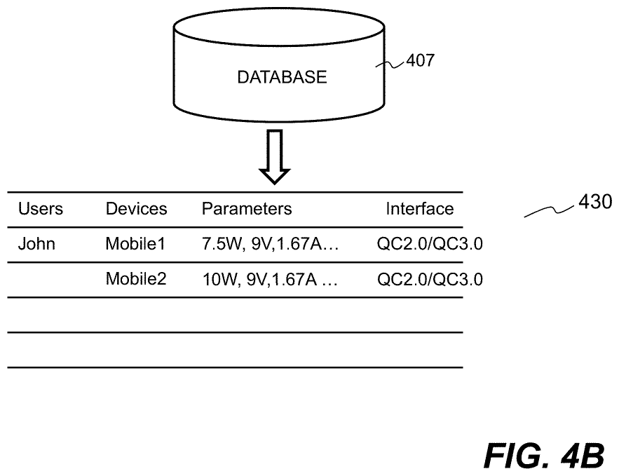

Referring now to FIG. 4A, there is shown a functional block diagram of a server 400 in which a server module 402 resides in a memory space 403 and is executed by one or more processors 401. The server 400 is a representation of many similar servers operated by a business operating a plurality of charging pads or an ad publisher. The server 400 may be used in FIG. 1D as the server 156 to facilitate the management of the charging pads and allocation of ads for each of subscribers or users, arrangements between advertisers and each of the users, and settlements of payments or points towards the viewing of the ads.

Depending on implementation, this server 400 may be a single server or a cluster of two or more computing devices. One embodiment of the present invention is implemented as cloud computing in which there are multiple computers or servers deployed to serve as many businesses or individuals as practically possible. For illustration purpose, a single server 400 is shown in FIG. 4A. Further, the server 400 includes a network interface 404 to facilitate the communication between the server 400 and other devices on a network, and a storage space 405. In one embodiment, the server module 402 is an executable version of one embodiment of the present invention and delivers, when executed, some or all of the features/results contemplated in the present invention. It should be noted that a general computing device is not able to perform or deliver what the server 400 is equipped to do without the installation of or access to the server module 402.

According to one embodiment, the server module 402 comprises an administration interface 406, an account manager 408, a client (advertiser) manager 410, a security manager 412, an advertisement manager 414, a data processing module 416 and a payment manager 418.

### Administration Interface 406:

As the name suggests, the administration interface 406 facilitates a system administrator to access various components in the server module 402 and set up various parameters of the components. In one embodiment, a publisher uses the administration interface 406 to determine a spread for its profit. For example, an advertiser is willing to pay $0.90 for a user to view an ad. The publisher may extract a fee (e.g., 25%) on the payment from the advertiser, thus the maximum the user can get paid is $0.675 (75%×0.90) for viewing the ad, where the payment is counted towards points that may be used for free charging or purchasing other advertised items or services. In another embodiment, the administration interface 406 allows a publisher to manage all subscribing accounts for the advertisers and determine what and how much to charge for servicing the advertisers. In addition, advertisements in digital forms are received from the advertisers and kept in storage 405 or a database 407 via the administration interface 406.

### Account Manager 408:

The account manager 408 is provided to allow a user to automatically register himself with the server 400 for a service (e.g., charging) being offered by the server 400 or register with a client module running on his mobile device, where the client module is designed to cause his mobile device to communicate with the server 400 via the interface 404. In one example, a user causes the client module to be executed for the first time on his device (e.g., iPhone), the module is designed to request the user to enter certain information (e.g., username/password, a fingerprint, a true name and etc.) before allowing the user to create an account, including a profile, for receiving payments or points. In one embodiment, a user is allowed to link his electronic wallet to his account. Whenever there is a payment from an advertiser or the ad publisher, the payment goes to his electronic wallet. After the registration, a profile of the user is created and then transported to the server 400. According to one embodiment, the account manager 408 indicates to the server 400 that a user who has expressed a plan to purchase an item (e.g., a TV or a tablet computer), the server module 402 is designed to take a special care of the user by notifying the advertisers of the purchase intent from the user. Depending on implementation, some advertisers may make a special promotion of the item or items similar to what is in the mind of the user. The promotion may be one or more of a special discount, a voucher, a rebate or other appended services/products. Not only viewing the ad or ads from these advertisers for a competing payment, the user may get additional perks by clicking through all the way to a successful transaction of purchasing an item being advertised.

### Client Manager 410

The client manager 410 is provided to manage versions of client modules provided to the users. In one embodiment, besides keeping updates to the client module, there may be several versions of it, for example, one for paying cash to users for viewing the ads being distributed by the publisher, and the other for paying users points for free charging. Depending on implementation, these versions of the client module may be implemented as a single module or separate modules. In the context of the present invention, the client manager 410 controls when to switch from one version to another in accordance with a set of parameters about a user. In operation, the client manager 410 is notified which version or release a registered user is using. In addition, the client manager 410 may be charged to determine the parameters that shall be used for interface matching when charging. In other words, when the server 400 is notified that a mobile device is placed near or on a charging pad, the client manager 410 looks up a set of parameters in a look-up table. As an example, FIG. 4B shows an exemplary look-up table 430 that lists registered devices under one user. When the user first registered his device, the charging interface of the device may be obtained from a reliable source (e.g., from the manufacturer). For each device the user has registered, there is a corresponding set of parameters. As described above, these parameters are used to facilitate the adjustment of the charging interface of the charging pad that is being engaged with the device for matching.

### Security Manage 412

This module is configured to provide security when needed. The stored data for each of the subscribing businesses or registered users may be encrypted, thus only an authorized user may access the secured data. For example, all personal information of the users, especially the accounts set up by the users to receive the payments for viewing the ads are stored securely. In one embodiment, the security manage 412 is configured to initiate a secure communication session with a client device when the user of the client device shall be paid. The secure session allows a payment to be made to the designated account. In addition, the profile and preferences provided by the user are also secured by the security manager 412.

### Advertisement Manager 414

The advertisement manager 414 is a tool provided to allocate one or more advertisements for a user in accordance with his provided profile, where the advertisements are chosen based on certain criteria set by the ad publisher or/and the user. Depending on implementation, the criteria may be based on a profile provided by the user or a profile retrieved from a social network, where the user allows an access to his profile on the social network and shares his interests with others there. In addition, the publisher has also establish the criteria as so a purchase history, a historical browsing habit, possible buying power and other considerations. For example, the advertisement manager 414 would never allocate female cosmetic advertisements to a male user. Likewise the advertisement manager 414 may be designed not to allocate female cosmetic advertisements to a female user if it is detected that the female user has never clicked through a cosmetic advertisement. In operation, the Advertisement manager 414 is designed to periodically or constantly reallocate advertisements for each of the users based on a set of parameters to maximize the delivery and usefulness of the respectively allocated ads.

### Data Processing 416:

This module is configured to perform analytic operations to determine which ad to be shown next after a user has viewed one ad. Given the information provided by a user and the payment range by an advertiser or the publisher, the data processing module 416 determines a set of ads in an order for the user. In operation, the data processing module 416 is designed to be periodically or continuously executed to keep the allocated ads in an order that is believed to be most effective. In one embodiment, there may be a few ads from one or more advertisers that are believed suitable for a user, each ad is set for a price for the user. When two or more ads are substantially similar, the order of showing the ads is very important for certain items. A user may click through an ad and complete a transaction with the ad, resulting in subsequent similar ads relatively or completely useless. According to one embodiment, whenever such a transaction happens, the data processing module 416 is designed to calculate a set of parameters that cause the advertisement manager 414 to reallocate some or all of the ads for the user. In one case, the subsequent similar ads are withdrawn or the payout for each of the subsequent similar ads is significantly reduced. In another case, the data processing module 416 is designed to calculate a set of parameters that cause the advertisement manager 414 to allocate new ads of items or services that could supplement or expand the use of the purchased item by the user. In the above example of purchasing a smart TV by a user, once the transaction of the purchase is done, further TV ads would be ignored to avoid the waste of money offered by TV manufacturers or TV stores for viewing their TV ads. Instead, it would be much more efficient or useful to send ads related to a cable service or TV accessories or other services (e.g., HDMI cable, surrounding speaker system or extended warranty). In still another case, the user may want to delete an advertiser (perhaps the user has had a bad experience with a product from the advertiser) or add a preferable advertiser (perhaps the user is fascinated with a brand from the advertiser), the data processing module 416 is designed to calculate a set of parameters that cause the advertisement manager 414 to reallocate ads for the user every time there is a change to his profile or an action to a viewed ad. According to another embodiment, certain social network pages (e.g., Facebook) owned by a user are crawled to determine an interest of the user from his interactions with certain applications or visits to certain websites. It is assumed that such access is permitted or opted-in by the user. The retrieved data is analyzed by the data processing module 416 so that the advertisement manager 414 can update or allocate ads for the user.

### Payment Manager 418:

As the name suggests, this module is designed to settle the payment with a user after the user views one or more allocated ads for him. In operation, this module works with the account manager 408 and the data processing unit 416 to ensure that an allocated ad is viewed by the user and the user is compensated for viewing the ad. Should the user has done something extra about the ad, the user is awarded with an extra payment or payments. As described above, when viewing an ad, the user may click it though, result in a transaction from it, forward it to a friend or post it on a whitewall on social network and etc. Each or all of the subsequent actions may get the user some extra payments for viewing the ad. Afterwards, the payment is made electronically by the payment manager 418 to a designated account by the user. In one embodiment, the payment manager 418 settles the payment with an account in a mobile device associated with the user.

The present invention has been described in sufficient detail with a certain degree of particularity. It is understood to those skilled in the art that the present disclosure of embodiments has been made by way of examples only and that numerous changes in the arrangement and combination of parts may be resorted without departing from the spirit and scope of the invention as claimed. Accordingly, the scope of the present invention is defined by the appended claims rather than the forgoing description of embodiments.

I claim:

1. A system for wireless charging management, the system comprising:
a server managing remotely a plurality of charging pads, each of the charging pads being disposed in an establishment to allow mobile devices to get wireless charging therefrom;
each of the charging pads including:
a charging interface detecting a presence of a mobile device when the mobile device is placed near or on top of the each of the charging pads;
a controller, coupled to the charging interface, programmed to send out a signal activating a designated application installed in the mobile device to be executed therein; and
a network interface receiving a set of parameters from the server responding to a data set received from the mobile device over a data network, wherein the controller controls charging service so that the each of the charging pads starts or refuses charging the mobile device.

2. The system as recited in claim 1, wherein the data set includes a plurality of parameters, the controller relies upon the parameters to reconfigure the charging interface to match with the mobile device for optimum wireless charging.

3. The system as recited in claim 2, wherein the parameters include at least a wattage requirement to charge the mobile device through the charging interface.

4. The system as recited in claim 3, wherein the parameters further include coupling parameters between the each of the charging pads and the mobile device for optimum wireless charging.

5. The system as recited in claim 4, wherein the coupling parameters include inductance.

6. The system as recited in claim 2, wherein the controller operates the each of the charging pads for a period of time in accordance with the data set including a time limit to charge the mobile device.

7. The system as recited in claim 6, wherein the each of the charging pads further includes:
a display, wherein the display automatically displays targeted messages while the mobile device is being charged from the each of the charging pads, the targeted messages are allocated in the server for a user of the mobile device.

8. The system as recited in claim 7, wherein the server executing a server module maintains an account for the user, the account includes a profile and earns credits while the user views targeted messages.

9. The system as recited in claim 8, wherein the credits are used to pay for charging the mobile device via the each of the charging pads.

10. The system as recited in claim 8, wherein the targeted messages are updated according to viewing activities by the user.

11. A method for wireless charging management, the method comprising:
receiving in a server a data set from a mobile device over a data network, where in the data set includes an exact location of a charging pad, wherein the charging pad includes:
a charging interface detecting a presence of the mobile device when the mobile device is placed near or on top of the charging pads;
a controller, coupled to the charging interface, programmed to send out a signal activating a designated application installed in the mobile device to be executed therein; and
a network interface;
sending out a set of parameters from the server to the charging pad in responding to the data set, wherein the parameters cause the controller to start or refuse charging the mobile device from the charging pad.

12. The method as recited in claim 11, wherein the data set includes a plurality of parameters, the controller relies upon the parameters to reconfigure the charging interface to match with the mobile device for optimum wireless charging.

13. The method as recited in claim 12, wherein the parameters include at least a wattage requirement to charge the mobile device through the charging interface.

14. The method as recited in claim 13, wherein the parameters further include coupling parameters between the each of the charging pads and the mobile device for optimum wireless charging.

15. The method as recited in claim 14, wherein the coupling parameters include inductance.

16. The method as recited in claim 12, further comprising:
turning on the charging pad to charge the mobile device for a limited period in accordance with an account of the user associated with the mobile device.

17. The method as recited in claim 16, further comprising:
updating targeted messages while the mobile device is being charged from the charging pad, the targeted messages are allocated in the server specifically for the user in accordance with a profile of the user.

18. The method as recited in claim 17, further comprising:
executing a server module to manage a plurality of charging pads and maintain a plurality of accounts for users wishing to use any of the charging pads, each of the accounts includes a profile and earns credits while a user views any of the targeted messages.

19. The method as recited in claim 8, wherein the targeted messages are updated according to viewing activities by the user and the exact location.
